(19) United States
(12) Patent Application Publication
(10) Pub. No.: US 2015/0019955 A1
(43) Pub. Date: Jan. 15, 2015

(54) METHOD AND SYSTEM FOR DISPLAYING LITERAL CONTENTS, MOBILE TERMINAL, CLOUD TYPESETTING SERVER, AND STORAGE MEDIUM

(71) Applicant: TENCENT TECHNOLOGY (SHENZHEN) COMPANY LIMITED, Shenzhen (CN)

(72) Inventors: Yongxia LIU, Shenzhen (CN); Xuebin LIU, Shenzhen (CN); Jiejun ZHANG, Shenzhen (CN); Feng JIANG, Shenzhen (CN); Kaixiang ZHANG, Shenzhen (CN)

(21) Appl. No.: 14/503,854

(22) Filed: Oct. 1, 2014

Related U.S. Application Data
(63) Continuation of application No. PCT/CN2013/087967, filed on Nov. 27, 2013.

(30) Foreign Application Priority Data
Feb. 5, 2013 (CN) 201310046206.3

(51) Int. Cl. G06F 17/30; H04L 29/08

(52) U.S. Cl. CPC G06F 17/30896; G06F 17/30905; H04L 67/02; H04L 67/10
USPC 715/235

(57) ABSTRACT

A method, a system, a mobile terminal and a cloud typesetting server for displaying literal contents, and a storage medium are described. The method includes: reporting, by a mobile terminal for displaying literal contents, a character style set identifier to a cloud typesetting server, wherein the character style set identifier is used for identifying a character style set corresponding to the mobile terminal, and the character style set includes character styles supported by the mobile terminal; receiving, by the mobile terminal, typesetting information, which is obtained by the cloud typesetting server via typesetting the literal contents to be displayed according to the matching character style data selected from the identified character style data; and displaying literal contents by the mobile terminal according to the typesetting information. By the method, the typesetting with various font styles supported by mobile Internet applications is realized at the cloud side.

### CROSS-REFERENCE TO RELATED APPLICATION

This application claims priority to and is a continuation application of PCT/CN2013/087967, filed on Nov. 27, 2013 and entitled “METHOD AND SYSTEM FOR DISPLAYING LITERAL CONTENTS, MOBILE TERMINAL, CLOUD TYPESETTING SERVER, AND STORAGE MEDIUM”, which claims the benefit of Chinese Application No. 201310046206.3, filed on Feb. 5, 2013 by Tencent Technology (Shenzhen) Co., Ltd., titled “METHOD AND SYSTEM FOR DISPLAYING LITERAL CONTENTS, MOBILE TERMINAL AND CLOUD TYPESETTING SERVER”, which are incorporated herein by reference in their entirety.

### FIELD OF THE INVENTION

The present disclosure relates to the field of mobile Internet technologies, and in particular, to a method and a system for displaying literal contents, a mobile terminal, a cloud typesetting server and a storage medium.

### BACKGROUND OF THE INVENTION

Mobile Internet technologies are important for Internet applications. Since different mobile terminals having different sizes and systems are used by users to access the Internet, if the same literal contents are displayed in the same display style on different terminals (for example, the same literal contents are displayed in the same size on different types of intelligent mobile phones), an intelligent mobile phone with a small screen might not completely show the literal contents, as a result, the literal contents to be displayed (for example, literal contents in a web page) need to be re-typesetted.

At present, considering the limited capabilities of a mobile terminal and the purposes of reducing the size of an application installation package, improving the browsing performance of an application and improving the running smoothness of an application in a weak network environment, the complex typesetting logic is usually implemented on the side of a server (also referred to as cloud) in the prior art, that is, a web page or literal contents to be displayed is typesetted on the side of the server, and then the typesetting information is sent to the mobile terminal for displaying, so that the mobile terminal displays the effect of the typesetting obtained at the cloud side directly.

However, for the existing solution of typesetting at the side of the server, the literal style finally displayed on a mobile terminal is simple, for example, the literal contents on the whole page are shown in only a single font size, which is limitedly selected from a large font size, a medium font size and a small font size; and the literal contents on the whole page cannot be shown in multiple font styles (for example, italic, bold and underlined font styles). Furthermore, the font style and the font size supported by a mobile terminal may be different from those supported by another mobile terminal, and if the fixed typesetting information is sent from the server to the various mobile terminals, a part of the mobile terminals might not support the font style and the font size contained in the typesetting information, thus the literal contents to be displayed might be displayed incorrectly.

### SUMMARY OF THE INVENTION

The embodiments of the invention provide a method and a system for displaying literal contents, a mobile terminal, a cloud typesetting server and a storage medium, for the purpose of typesetting with a character style including various font styles and various font sizes at the cloud side.

On a first aspect, an embodiment of the invention provides a method for displaying literal contents, comprising:

reporting, by a mobile terminal for displaying literal contents, a character style set identifier to a cloud typesetting server, where the character style set identifier is used for identifying a character style set corresponding to the mobile terminal, and the character style set includes character styles supported by the mobile terminal;

receiving, by the mobile terminal for displaying literal contents, typesetting information, which is obtained by the cloud typesetting server via identifying the character style data of the character style set corresponding to the mobile terminal according to the character style set identifier and typesetting the literal contents according to the matching character style data selected from the identified character style data, where the character style data are prestored on the cloud typesetting server and used for typesetting and displaying in the corresponding character style; and

displaying literal contents by the mobile terminal according to the typesetting information.

On a second aspect, an embodiment of the invention further provides a mobile terminal, which comprises a character style set identifier reporting unit, a typesetting information receiving unit and a displaying unit;

the character style set identifier reporting unit is configured to report a character style set identifier to a cloud typesetting server, where the character style set identifier is used for identifying a character style set corresponding to the mobile terminal, and the character style set includes character styles supported by the mobile terminal;

the typesetting information receiving unit is configured to receive typesetting information, which is obtained by the cloud typesetting server via identifying the character style data of the character style set corresponding to the mobile terminal according to the character style set identifier and typesetting the literal contents to be displayed according to the matching character style data selected from the identified character style data, and the character style data are used for the typesetting and displaying in the corresponding character style; and

the displaying unit is configured to display the literal contents according to the typesetting information.

On a third aspect, an embodiment of the invention further provides a cloud typesetting server, which comprises a character style set identifier receiving unit and a typesetting unit;

the character style set identifier receiving unit is configured to receive a character style set identifier reported by the mobile terminal, where the character style set identifier is used for identifying a character style set corresponding to the mobile terminal, and the character style set includes character styles supported by the mobile terminal;

the typesetting unit is configured to identify the character style data of the character style set corresponding to the mobile terminal according to the character style set identifier, obtaining typesetting information by typesetting literal contents to be displayed according to the matching character style data selected from the identified character style data, and sending the typesetting information to the mobile terminal;

where, the character style data are used for the typesetting and displaying in the corresponding character style.

On a fourth aspect, an embodiment of the invention further provides a system for displaying literal contents, which includes a mobile terminal and a cloud typesetting server;

the mobile terminal reports a character style set identifier to the cloud typesetting server, the character style set identifier is used for identifying a character style set corresponding to the mobile terminal, and the character style set includes character styles supported by the mobile terminal;

the cloud typesetting server identifies character style data of the character style set corresponding to the mobile terminal according to the character style set identifier, obtains typesetting information by typesetting the literal contents to be displayed according to the matching character style data selected from the identified character style data, and sends the typesetting information to the mobile terminal, wherein the character style data are used for the typesetting and displaying in the corresponding character style; and

the mobile terminal displays the literal contents according to the typesetting information.

On a fifth aspect, an embodiment of the invention further provides a storage medium containing computer-executable instructions, which, when executed by a computer processor, are configured to perform a method for displaying literal contents, and the method includes:

reporting, by a mobile terminal for displaying literal contents, a character style set identifier to a cloud typesetting server, where the character style set identifier is used for identifying a character style set corresponding to the mobile terminal, and the character style set includes character styles supported by the mobile terminal;

receiving, by the mobile terminal, typesetting information, which is obtained by the cloud typesetting server via identifying the character style data of the character style set corresponding to the mobile terminal according to the character style set identifier and typesetting the literal contents to be displayed according to the matching character style data selected from the identified character style data, and the character style data are prestored on the cloud typesetting server and used for the typesetting and displaying in the corresponding character style; and

displaying literal contents by the mobile terminal according to the typesetting information.

In the embodiments of the invention, a unique identifier is assigned to a character style including various font styles and/or font sizes supported by a mobile terminal and a character style set identifier is assigned to a character style set consisted of all character styles supported by a certain mobile terminal, so that the server may identify the character style including a font style and a font size supported by the mobile terminal according to the character style set identifier reported by the mobile terminal, and literal contents may be typesetted and adapted for displaying on the mobile terminal according to a suitable font style and a suitable font size selected for the literal contents as per the character style identified. Therefore, the typesetting with a character style including various font styles and various font sizes can be realized at the could side in the disclosure.

### BRIEF DESCRIPTION OF THE DRAWINGS

FIG. 1 is a flow chart of a method for displaying literal contents according to one embodiment of the invention;

FIG. 2 is a flow chart of a method for displaying literal contents according to another embodiment of the invention;

FIG. 3 is a schematic diagram of the character style set data generated by a mobile terminal in a preferred implementation of the another embodiment of the invention;

FIG. 4 is a schematic diagram of the character style data in a preferred implementation of the another embodiment of the invention;

FIG. 5 is a schematic diagram of the character style set information reported by the mobile terminal in a preferred implementation of the another embodiment of the invention; and

FIG. 6 is a block diagram of a system for displaying literal contents according to yet another embodiment of the invention.

### DETAILED DESCRIPTION OF THE EMBODIMENTS

The technical solutions of the disclosure will be further illustrated below by specific embodiments in conjunction with the drawings.

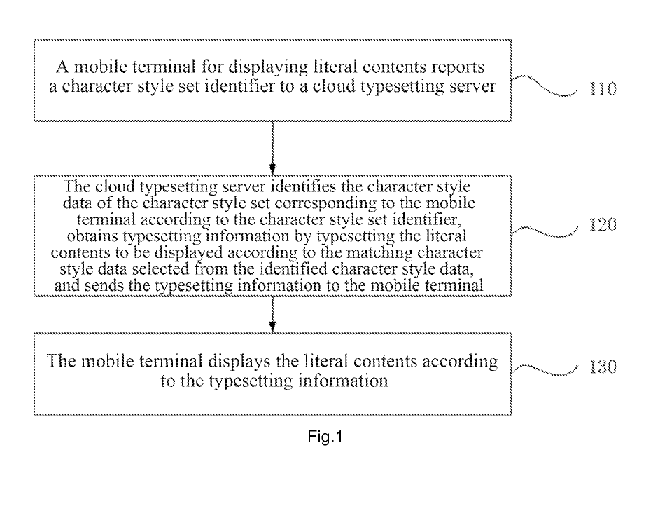

FIG. 1 is a flow chart of a method for displaying literal contents according to one embodiment of the invention. As shown in FIG. 1, the method includes Steps 110-130 below.

At Step 110, a mobile terminal for displaying literal contents reports a character style set identifier to a cloud typesetting server.

The character style set identifier is used for identifying a character style set corresponding to the mobile terminal, and the character style set includes character styles supported by the mobile terminal.

The character style set identifier is a unique identifier for a character style set.

At Step 120, the cloud typesetting server identifies the character style data of the character style set corresponding to the mobile terminal according to the character style set identifier, obtains typesetting information by typesetting the literal contents to be displayed according to the matching character style data selected from the identified character style data, and sends the typesetting information to the mobile terminal. The character style data are prestored on the cloud typesetting server and used for the typesetting and displaying in the corresponding character style, and describe the display style supported by the mobile terminal, for example, various font styles, font sizes and/or effects, etc. For example, the character style data describe the display style of a bold font #5 corresponding to the mobile terminal, such as the length and width.

Correspondingly, the mobile terminal needs to receive the typesetting information.

The character style data may be configured and stored on a cloud typesetting server by an operator in advance, or may be uploaded to the cloud typesetting server by other mobile terminals, or may be reported by the mobile terminal for displaying literal contents itself.

The cloud typesetting server according to this embodiment may be diversified as required, and may be an independent server or a centralized server cluster arranged at the same location, or a distributed server cluster including servers arranged at different locations and communicated with each other.

At Step 130, the mobile terminal for displaying literal contents displays the literal contents according to the typesetting information.

In the embodiments of the invention, a unique identifier is assigned to a character style including various font styles and/or font sizes supported by a mobile terminal and a character style set identifier is assigned to a character style set consisted of all character styles supported by a certain mobile terminal, so that the server may identify the character style including a font style and a font size supported by the mobile terminal according to the character style set identifier reported by the mobile terminal, and literal contents may be typesetted and adapted for displaying on the mobile terminal according to a suitable font style and a suitable font size selected for the literal contents as per the character style identified. Therefore, the typesetting with a character style including various font styles and various font sizes can be realized at the could side in the disclosure.

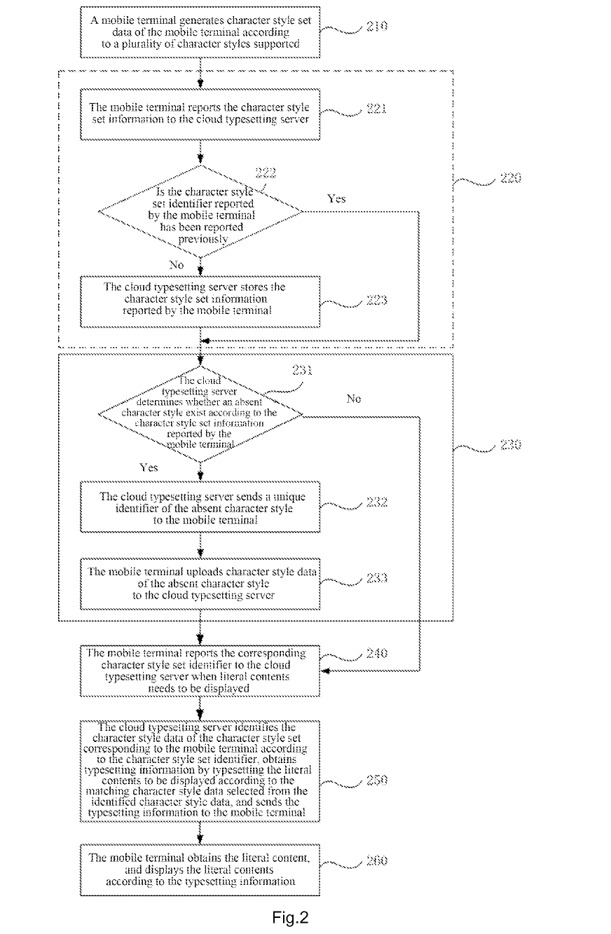

FIG. 2 is a flow chart of a method for displaying literal contents according to another embodiment of the invention. As shown in FIG. 2, the method includes Steps 210-260 below.

At Step 210, a mobile terminal generates its character style set data according to a plurality of character styles supported.

The character style set data includes a character style set identifier, the character style data of the plurality of character styles supported by the mobile terminal and the corresponding unique identifier. In the disclosure, each character style may include a font, font style, font size and/or character effect different from those of other character styles.

In a preferred implementation of this embodiment, the mobile terminal calculates the unique identifier corresponding to the character style data by a Message-Digest Algorithm 5 (MD5 algorithm).

In another preferred embodiment of the invention, the mobile terminal calculates a character style set identifier uniquely corresponding to a set of all the unique identifiers based on all the unique identifiers in the character style set by the MD5 algorithm.

However, it may be understood by one skilled in the art that, the unique identifier and the character style set identifier may also be obtained in other manners, for example, by using other digital fingerprint generation algorithms.

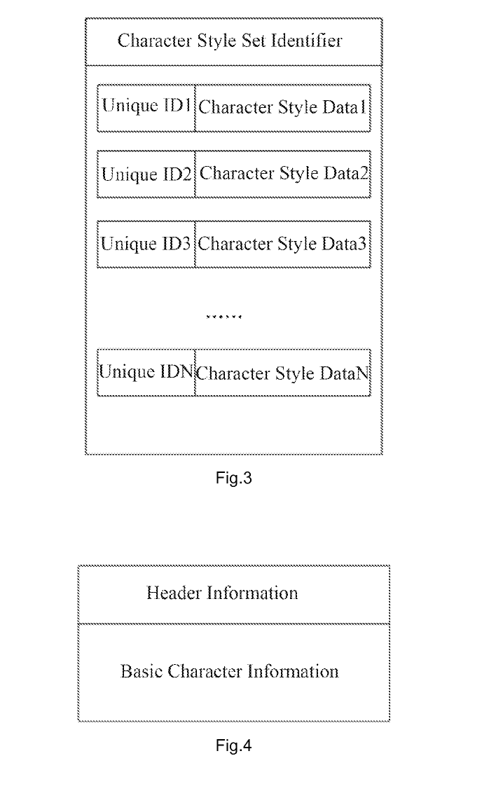

In a preferred embodiment of the invention, each character style has a different font style and/or font size. FIG. 3 is a schematic diagram of the character style set data generated by a mobile terminal in this preferred embodiment, and FIG. 4 is a schematic diagram of the character style data in this preferred embodiment. As shown in FIGS. 3 and 4, each character style set data includes a character style set identifier, the character style data of the plurality of character styles supported by the mobile terminal and the corresponding unique identifier, and the character style data corresponding to each character style include information of the corresponding character set, such as character size, font, font style, height and width, etc. Herein, the character set is a universal font library consisted of characters such as letters, digits, Chinese characters and/or special symbols that can be displayed by a terminal. The character style data may include: header information, which includes the common information of all characters in the character set, for example, character size, font style and height; and basic character information, which includes the characteristic information of each character in the character set, for example, the width of each character, etc. For the character style set data, the character style data may be identified conveniently by the unique identifier, or the corresponding character style may be selected for typesetting by matching the header information of the character style data.

At Step 220, the mobile terminal reports the character style set information to a cloud typesetting server in advance.

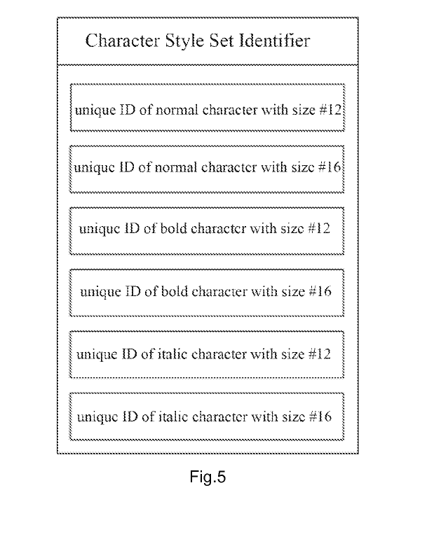

FIG. 5 is a schematic diagram of the character style set information reported by the mobile terminal according to a preferred implementation of this embodiment. As shown in FIG. 5, the character style set information includes a character style set identifier for uniquely identifying the character style set and unique identifiers for a plurality of character styles in the character style set; for example, the character style set information shown in FIG. 5 includes a character style set identifier, and the unique identifiers for six character styles with different font styles and/or font sizes, i.e., a unique identifier for a normal character with a size #12, a unique identifier of a normal character with a size #16, a unique identifier of a bold character with a size #12, a unique identifier of a bold character with a size #16, a unique identifier of an underlined character with a size #12 and a unique identifier of an underlined character with a size #16.

In this embodiment, the reporting operation of the mobile terminal may be triggered when an application with a cloud typesetting function is initially started, or may also be triggered by a user or any other preset conditions.

Step 220 specifically includes Steps 221-223:

Step 221: the mobile terminal reports the character style set information to the cloud typesetting server.

Step 222: the cloud typesetting server determines whether the character style set identifier reported by the mobile terminal has been reported previously; and if the same character style set identifier has been reported by another mobile terminal, Step 230 is performed; otherwise, Step 223 is performed.

In a preferred implementation of this embodiment, if the character style set identifier is calculated from all the unique identifiers in the character style set and corresponds these unique identifiers, the cloud typesetting server may determine whether the same character style set information has been reported by only determining whether the character style set identifier has been uploaded.

Step 223: the cloud typesetting server stores the character style set information reported by the mobile terminal.

The cloud typesetting server stores a mapping relation between the character style set identifier and each of the unique identifiers in the set; thus, the unique identifier of the character style supported by the mobile terminal that reports the character style set information may be identified via the character style set identifier.

After Step 220, the cloud typesetting server stores the character style set information of the mobile terminal for displaying literal contents.

Step 230: the mobile terminal reports to the cloud typesetting server the character style data of an absent character style, i.e. a character style which is among the character styles supported by the mobile terminal but not stored in the cloud typesetting server.

Specifically, Step 230 includes:

Step 231: the cloud typesetting server determines whether the absent character style exists according to the character style set information reported by the mobile terminal, and if so, Step 240 is performed; otherwise, Step 232 is performed.

Due to the numerous types of mobile terminals and the different operating systems as used, the character styles supported are numerous and complicated, and it is difficult to collect data of all the character styles; as a result, the problem is solved in this embodiment by uploading the character style data to the cloud typesetting server from the mobile terminal.

Moreover, in this embodiment, the cloud typesetting server determines whether the absent character style exists according to the character style set information reported by the mobile terminal. Therefore, if a certain character style data has been uploaded by a mobile terminal, any other mobile terminals need not to upload this character style data again. Thus, the data upload operation performed by the mobile terminals may be reduced, and the network traffic may be saved.

Specifically, the cloud typesetting server stores the existing character style data and the corresponding unique identifier independently of the above character style set information. When performing the above Step 231, the cloud typesetting server determines whether the absent character style exists by querying the unique identifiers stored independently.

Step 232: the cloud typesetting server sends a unique identifier of the absent character style to the mobile terminal.

Correspondingly, the mobile terminal receives the unique identifier of the absent character style.

Step 233: the mobile terminal uploads character style data of the absent character style to the cloud typesetting server.

In a preferred implementation of this embodiment, the mobile terminal may upload the character style data absent in the cloud typesetting server in batches according to preset priorities; for example, when both multiple sets of character style data of a normal font style and multiple sets of character style data of a bold font style are absent in the server, the multiple sets of character style data of the normal font style will be uploaded preferentially, and the character style data of the bold font style will be uploaded later according to a preset triggering condition; thereby, the network traffic of the mobile terminal may be further saved.

In another preferred implementation of this embodiment, the mobile terminal may compress and then upload the character style data, thereby further saving the network traffic of the mobile terminal.

The above two preferred uploading modes may be used independently or in combination.

As described above, in this embodiment, the cloud typesetting server stores the existing character style data and the corresponding unique identifier independently of the above character style set information.

Step 240: the mobile terminal reports the corresponding character style set identifier to the cloud typesetting server when literal contents need to be displayed.

Step 250: the cloud typesetting server identifies the character style data of the character style set corresponding to the mobile terminal according to the character style set identifier, obtains typesetting information by typesetting the literal contents to be displayed according to the matching character style data selected from the identified character style data, and sends the typesetting information to the mobile terminal, where the character style data are used for the typesetting and displaying in the corresponding character style.

In a preferred implementation of this embodiment, for the case that the character style only includes a font style and a font size, Step 250 may specifically include Steps 251-253 below which are not shown in FIG. 2.

Step 251: the style information of literal contents to be displayed is obtained, where the style information includes a font style and a font size.

When the mobile terminal sends a page access request to a third-party website server, the third-party website server returns corresponding literal contents to be displayed to the mobile terminal, but the style information of the literal contents is set by the third-party website server. In order to re-typeset the literal contents to be displayed by the mobile terminal, the literal contents returned by the third-party website server are intercepted and then re-typesetted by the mobile terminal or a cloud typesetting server in the prior art. In the embodiment of the invention, however, the cloud typesetting server obtains the intercepted literal contents and extracts the style information therefrom.

Step 252: a character style that has the same font style as and the most proximate font size to those of the obtained literal contents for displaying is selected from the character style set corresponding to the mobile terminal.

In this embodiment, the character style that has the most proximate font size to that of the obtained literal contents may be searched in a cascade proximity matching mode. For example, the font size of the obtained literal contents is 13, but the mobile terminal supports only five font sizes, i.e., font sizes 12, 15, 20, 24 and 28, then the most proximate font size is 12, thus a character style with the font size 12 is selected as the typesetting style. In another example, for the mobile terminal that supports only five font sizes, i.e., font sizes 12, 15, 20, 24 and 28, if the font size of the obtained literal contents is 14, then the most proximate font size is 15, thus a character style with the font size 15 is selected as the typesetting style.

This matching process may be realized by searching in the header information of the character style data.

Step 253: the typesetting information is obtained by typesetting the literal contents according to the character style data corresponding to the selected character style, and the typesetting information is sent to the mobile terminal.

The typesetting information sent by the cloud typesetting server to the mobile terminal contains information such as typesetting style and character style, so that the mobile terminal may display the literal contents in the format typesetted by the server.

Step 260: the mobile terminal obtains and then displays the literal contents according to the typesetting information.

In this embodiment, the cloud typesetting server may be diversified as required, and may be an independent server or a centralized server cluster arranged at the same location, or a distributed server cluster including servers arranged at different locations and communicated with each other.

In this embodiment, the mobile terminal uploads the character style data to the cloud typesetting server autonomously, so that the cloud typesetting server may adaptively generate the typesetting information of literal contents to be displayed that corresponds to various types of mobile terminals with different operating systems, and the compatibility of the method for displaying literal contents may be improved; at the same time, the network traffic of the mobile terminal may be saved by such optimized mode of uploading the character style data.

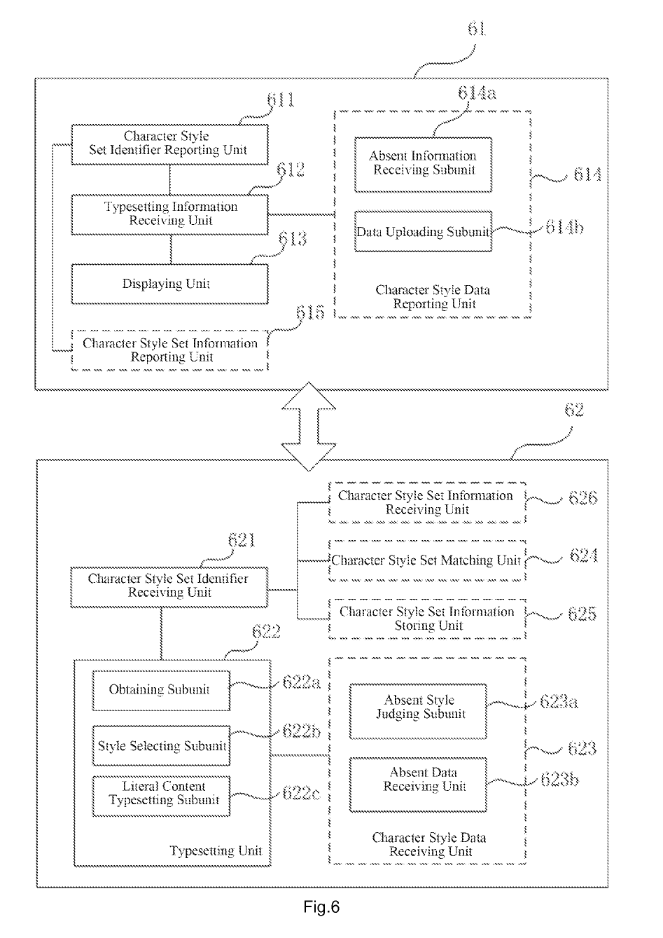

FIG. 6 is a schematic diagram of a system for displaying literal contents according to yet another embodiment of the invention. As shown in FIG. 6, the system for displaying literal contents at least includes a mobile terminal 61 and a cloud typesetting server 62.

The mobile terminal 61 reports a character style set identifier to the cloud typesetting server 62, where the character style set identifier is used for identifying a character style set corresponding to the mobile terminal 61, and the character style set includes character styles supported by the mobile terminal 61.

The cloud typesetting server 62 identifies the character style data of the character style set corresponding to the mobile terminal 61 for displaying literal contents according to the character style set identifier, obtains typesetting information by typesetting the literal contents according to the matching character style data selected from the identified character style data, and sends the typesetting information to the mobile terminal 61, where the character style data are used for the typesetting and displaying in the corresponding character style.

The mobile terminal 61 obtains and displays the literal contents according to the typesetting information.

Specifically, the mobile terminal 61 in this embodiment includes a character style set identifier reporting unit 611, a typesetting information receiving unit 612 and a displaying unit 613.

The character style set identifier reporting unit 611 is adapted to report a character style set identifier to the cloud typesetting server 62, where the character style set identifier is used for identifying a character style set corresponding to the mobile terminal, and the character style set includes character styles supported by the mobile terminal 61.

The typesetting information receiving unit 612 is adapted to receive the typesetting information, which is obtained by the cloud typesetting server 62 via typesetting the literal contents to be displayed according to the matching character style data that is selected from the prestored character style data of the character style set corresponding to the mobile terminal 61 according to the character style set identifier.

The displaying unit 613 is adapted to display the literal contents according to the typesetting information.

Correspondingly, the cloud typesetting server 62 of the system for displaying literal contents includes a character style set identifier receiving unit 621 and a typesetting unit 622.

The character style set identifier receiving unit 621 is adapted to receive the character style set identifier reported by the mobile terminal 61, where the character style set identifier is used for identifying a character style set corresponding to the mobile terminal 61, and the character style set includes character styles supported by the mobile terminal 61.

The typesetting unit 622 is adapted to identify the character style data of the character style set corresponding to the mobile terminal 61 according to the character style set identifier, obtain typesetting information by typesetting the literal contents to be displayed according to the matching character style data selected from the identified character style data, and send the typesetting information to the corresponding mobile terminal 61.

Here, the character style data is used for the typesetting and displaying in the corresponding character style.

Specifically, the typesetting unit 622 includes an obtaining subunit 622a, a style selecting subunit 622b and a literal content typesetting subunit 622c.

The obtaining subunit 622a is adapted to obtain the style information of literal contents to be displayed, which includes a font style and a font size; the style selecting subunit 622b is adapted to select, from the character style set corresponding to the mobile terminal 61, a character style that has the same font style and the most proximate font size to those of the obtained literal contents to be displayed; and the literal content typesetting subunit 622c is adapted to obtain the typesetting information by typesetting the literal contents according to the character style data corresponding to the selected character style, and send the typesetting information to the mobile terminal 61.

In the embodiments of the invention, a unique identifier is assigned to a character style including various font styles and/or font sizes supported by a mobile terminal and a character style set identifier is assigned to a character style set consisted of all character styles supported by a certain mobile terminal, so that the server may identify the character style including a font style and a font size supported by the mobile terminal according to the character style set identifier reported by the mobile terminal, and literal contents may be typesetted and adapted for displaying on the mobile terminal according to a suitable font style and a suitable font size selected for the literal contents as per the character style identified. Therefore, the typesetting with a character style including various font styles and various font sizes can be realized at the could side in the disclosure.

In a preferred implementation of this embodiment, the mobile terminal 61 further includes a character style data reporting unit 614 (shown by a dashed line in the figure), which is adapted to upload character style data to the cloud typesetting server 62, where the character style data are used for the typesetting and displaying in the corresponding character style.

Specifically, the character style data reporting unit 614 may include:

an absent information receiving subunit 614a, which is used for receiving a unique identifier of an absent character style (i.e. a character style that is not yet stored in the cloud typesetting server) that is determined by the cloud typesetting server 62 according to all unique identifiers in the character style set reported by the mobile terminal 61; and

a data uploading subunit 614b, which is used for uploading character style data of the absent character style to the cloud typesetting server 62.

To further save the traffic, the data uploading subunit 614a may upload character style data of the absent character style in batches according to the preset priorities, and/or compress and then upload the character style data of the absent character style.

Correspondingly, the cloud typesetting server 62 further includes a character style data receiving unit 623 (shown by a dashed line in the figure), which corresponds to the character style data reporting unit 614 and is used for receiving the character style data uploaded by the mobile terminal 61, where the character style data are used for the typesetting and displaying in the corresponding character style.

Specifically, the character style data receiving unit 623 includes:

an absent style judging subunit 623a, which is used for determining a unique identifier of an absent character style according to all unique identifiers in the character style set reported by the mobile terminal 61 and sending the unique identifier to the mobile terminal 61; and

an absent data receiving unit 623b, which is used for receiving character style data of the absent character style uploaded by the mobile terminal 61.

In this embodiment, the mobile terminal 61 uploads character style data to the cloud typesetting server 62 autonomously, so that the cloud typesetting server 62 may adaptively generate the typesetting information of literal contents to be displayed corresponding to various types of mobile terminals 61 with different operating systems, and the compatibility of the solution for displaying literal contents may be improved.

In a preferred embodiment of the invention, the mobile terminal 61 further includes a character style set information reporting unit 615, which is used for uploading the prestored character style set information to the cloud typesetting server 62, where the character style set information includes a character style set identifier and the unique identifier of each character style in the character style set.

Preferably, the character style set identifier is calculated from the unique identifiers of all character styles in the character style set by a digital fingerprint generation algorithm, and the unique identifier is calculated from the corresponding character style data. The calculation algorithm may be based on the MD5 algorithm, or other digital fingerprint generation algorithms.

Correspondingly, the cloud typesetting server 62 further includes a character style set information receiving unit 626, which is used for receiving the character style set information.

The cloud typesetting server 62 further includes a character style set matching unit 624 and a character style set information storing unit 625 (shown by a dashed line in the figure).

The character style set matching unit 624 is adapted to determine whether the character style set identifier reported by the mobile terminal 61 has been reported previously.

The character style set information storing unit 625 is adapted to store the character style set identifier reported by the mobile terminal 61 and the unique identifiers of all character styles in the character style set, when the character style set identifier has not been reported previously.

The above units (including the character style set information reporting unit 615 of the mobile terminal 61, and the character style set information receiving unit 626, the character style set matching unit 624 and the character style set information storing unit 625 of the cloud typesetting server 62) can prevent the repeated uploading of the same character style set, so that the resources of the cloud typesetting server may be saved.

As similar to the first and second embodiments, the cloud typesetting server 62 may be diversified as required, and may be an independent server or a centralized server cluster arranged at the same location, or a distributed server cluster including servers arranged at different locations and communicated with each other.

In the embodiments of the invention, a unique identifier is assigned to a character style including various font styles and/or font sizes supported by a mobile terminal and a character style set identifier is assigned to a character style set consisted of all character styles supported by a certain mobile terminal, so that the server may identify the character style including a font style and a font size supported by the mobile terminal according to the character style set identifier reported by the mobile terminal, and literal contents may be typesetted and adapted for displaying on the mobile terminal according to a suitable font style and a suitable font size selected for the literal contents as per the character style identified. Therefore, the typesetting with a character style including various font styles and various font sizes can be realized at the could side in the disclosure.

Apparently, it should be understood by one skilled in the art that, the above each module or each step of the disclosure may be realized via a universal calculating apparatus, and all the modules or steps may be centralized on a single calculating apparatus or distributed on a network system consisted of a plurality of calculating apparatuses. Optionally, the above each module or each step of the disclosure may be realized via computer-executable program codes, which may be stored on a storage apparatus and executed by a calculating apparatus, or may be implemented as an integrated circuit module, or a plurality of modules or steps may be implemented as a single integrated circuit module. Therefore, the disclosure is not limited to any combination of certain hardware or software.

In addition, an embodiment of the invention further provides a storage medium containing computer-executable instructions, which are adapted to perform a method for displaying literal contents, and the method comprises steps of:

reporting, by a mobile terminal for displaying literal contents, a character style set identifier to a cloud typesetting server, where the character style set identifier is used for identifying a character style set corresponding to the mobile terminal, and the character style set includes character styles supported by the mobile terminal;

receiving, by the mobile terminal, typesetting information, which is obtained by the cloud typesetting server via identifying the character style data of the character style set corresponding to the mobile terminal according to the character style set identifier and typesetting the literal contents to be displayed according to the matching character style data selected from the identified character style data; and

displaying the literal contents by the mobile terminal according to the typesetting information.

The above description only shows some preferred embodiments of the invention, without limiting the scope of the disclosure. Various modifications and variations can be made to the disclosure by one skilled in the art. Therefore, all modifications, equivalent substitutions and improvements without departing from the spirit and scope of the disclosure should be contemplated by the protection scope of the disclosure.

what is claimed is:

1. A method for displaying literal contents, comprising:
reporting, by a mobile terminal for displaying literal contents, a character style set identifier to a cloud typesetting server, wherein the character style set identifier is used for identifying a character style set corresponding to the mobile terminal, and the character style set comprises character styles supported by the mobile terminal;
receiving, by the mobile terminal, typesetting information, which is obtained by the cloud typesetting server via identifying character style data of the character style set corresponding to the mobile terminal according to the character style set identifier and typesetting the literal contents to be displayed according to the matching character style data selected from the identified character style data, and the character style data is prestored on the cloud typesetting server and used for the typesetting and displaying in the corresponding character style; and
displaying the literal contents by the mobile terminal according to the typesetting information.

2. The method of claim 1, wherein, the prestored character style data of the character style set corresponding to the mobile terminal are uploaded to the cloud typesetting server by the mobile terminal for displaying literal contents or other mobile terminals in advance.

3. The method of claim 2, wherein, uploading the character style data to the cloud typesetting server in advance comprises:
receiving, by the mobile terminal, a unique identifier of an absent character style that is determined by the cloud typesetting server; and
uploading, by the mobile terminal, character style data of the absent character style to the cloud typesetting server.

4. The method of claim 2, wherein, the mobile terminal uploads the character style data of the absent character style to the cloud typesetting server in batches according to preset priorities; and/or
the mobile terminal compresses and then uploads the character style data of the absent character style to the cloud typesetting server.

5. The method of claim 1, wherein, the cloud typesetting server obtains the unique identifier of each character style corresponding to the character style set identifier according to prestored character style set information, and identifies the character style data of the character style set according to the unique identifier, wherein, the character style set information comprises a character style set identifier and the unique identifier of each character style in the character style set.

6. The method of claim 5, wherein, the prestored character style set information is uploaded to the cloud typesetting server by the mobile terminal for displaying literal contents or other mobile terminals.

7. The method of claim 6, wherein, uploading the character style set information to the cloud typesetting server in advance comprises:
reporting, by the mobile terminal, the character style set information to the cloud typesetting server; and
determining, by the cloud typesetting server, whether the character style set identifier reported by the mobile terminal has been reported previously; and
if the character style set identifier has not been reported, storing, by the cloud typesetting server, the character style set identifier reported by the mobile terminal and the unique identifiers of all character styles in the character style set.

8. The method of claim 5, wherein, the character style set identifier calculated from the unique identifiers of all character styles in the character style set by a digital fingerprint generation algorithm, and the unique identifier is calculated from the corresponding character style data by a digital fingerprint generation algorithm.

9. The method of claim 1, wherein, identifying by the cloud typesetting server the character style data of the character style set corresponding to the mobile terminal according to the character style set identifier and typesetting the literal contents to be displayed according to the matching character style data selected from the identified character style data, comprises:
obtaining the style information of literal contents to be displayed, which comprises a font style and a font size;
selecting, in the character style set corresponding to the mobile terminal for displaying literal contents, a character style that has the same font style and the most proximate font size to those of the obtained literal contents to be displayed; and
typesetting the literal contents to be displayed according to the character style data corresponding to the character style selected.

10. A mobile terminal, comprising a character style set identifier reporting unit, a typesetting information receiving unit and a displaying unit;
the character style set identifier reporting unit is configured to report a character style set identifier to a cloud typesetting server, wherein the character style set identifier is used for identifying a character style set corresponding to the mobile terminal, and the character style set comprises character styles supported by the mobile terminal;
the typesetting information receiving unit is configured to receive typesetting information, which is obtained by the cloud typesetting server via identifying the character style data of the character style set corresponding to the mobile terminal according to the character style set identifier and typesetting the literal contents to be displayed according to the matching character style data selected from the identified character style data, and the character style data is used for the typesetting and displaying in the corresponding character style; and
the displaying unit is configured to display the literal contents according to the typesetting information.

11. The mobile terminal of claim 10, further comprising: a character style data reporting unit, which is configured to upload the character style data to the cloud typesetting server in advance.

12. The mobile terminal of claim 11, wherein, the character style data reporting unit comprises an absent information receiving subunit and a data uploading subunit;
the absent information receiving subunit is configured to receive the unique identifier of an absent character style that is determined by the cloud typesetting server; and
the data uploading subunit is configured to upload character style data of the absent character style to the cloud typesetting server.

13. The mobile terminal of claim 12, wherein, the data uploading subunit uploads the character style data of the absent character style to the cloud typesetting server in batches according to preset priorities, and/or compresses and then uploads the character style data of the absent character style.

14. The mobile terminal of claim 10, wherein, the mobile terminal further comprises a character style set information reporting unit, which is configured to report the character style set information corresponding to the mobile terminal to the cloud typesetting server in advance, wherein the character style set information comprises a character style set identifier and the unique identifier of each character style in the character style set.

15. The mobile terminal of claim 10, wherein, the character style set identifier is calculated from the unique identifiers of all character styles in the character style set by a digital fingerprint generation algorithm, and the unique identifier is calculated from the corresponding character style data by a digital fingerprint generation algorithm.

16. A cloud typesetting server, comprising: a character style set identifier receiving unit and a typesetting unit;
the character style set identifier receiving unit is configured to receive the character style set identifier reported by the mobile terminal, wherein the character style set identifier is used for identifying a character style set corresponding to the mobile terminal, and the character style set comprises character styles supported by the mobile terminal;
the typesetting unit is configured to identify the character style data of the character style set corresponding to the mobile terminal according to the character style set identifier, obtaining typesetting information by typesetting the literal contents to be displayed according to the matching character style data selected from the identified character style data, and sending the typesetting information to the mobile terminal;
wherein, the character style data is used for the typesetting and displaying in the corresponding character style.

17. The cloud typesetting server of claim 16, further comprising: a character style data receiving unit, which is configured to receive the character style data uploaded by the mobile terminal.

18. The cloud typesetting server of claim 17, wherein, the character style data receiving unit comprises an absent style judging subunit and an absent data receiving unit;
the absent style judging subunit is configured to determine the unique identifier of an absent character style according to each unique identifier in the character style set reported by the mobile terminal and sending the unique identifier determined to the mobile terminal; and
the absent data receiving unit is configured to receive character style data of the absent character style uploaded by the mobile terminal.

19. The cloud typesetting server of claim 16, further comprising: a character style set information receiving unit, a character style set matching unit and a character style set information storing unit;
the character style set information receiving unit is configured to receive the character style set information reported by the mobile terminal, wherein the character style set information comprises a character style set identifier and the unique identifier of each character style in the character style set;
the character style set matching unit is configured to judge whether the character style set identifier reported by the mobile terminal has been reported previously; and
the character style set information storing unit is configured to store the character style set identifier reported by the mobile terminal and the unique identifiers of all character styles in the character style set when the character style set identifier has not been reported previously.

20. The cloud typesetting server of claim 16, wherein, the typesetting unit comprises an obtaining subunit, a style selecting subunit and a literal content typesetting subunit;
the obtaining subunit is configured to obtain the style information of literal contents to be displayed, which comprises a font style and a font size;
the style selecting subunit is configured to select, from a character style set corresponding to the mobile terminal, a character style that has the same font style and the most proximate font size to those of the obtained literal contents to be displayed; and
the literal content typesetting subunit is configured to typeset the literal contents to be displayed according to the character style data corresponding to the character style selected.
